(19) United States
(12) Patent Application Publication
(10) Pub. No.: US 2017/0255373 A1
(43) Pub. Date: Sep. 7, 2017

(54) METHOD, SYSTEM, AND PROGRAM STORAGE DEVICE FOR ANALYTICS IN AN INDUSTRIAL INTERNET OF THINGS

(71) Applicant: General Electric Company, Schenectady, NY (US)

(72) Inventors: Jeanette Marie Bruno, Saratoga, NY (US); Segar Soundiramourthy, Pleasanton, CA (US); Tun Tun Min Chang, San Ramon, CA (US)

(21) Appl. No.: 15/448,294

(22) Filed: Mar. 2, 2017

Related U.S. Application Data
(60) Provisional application No. 62/302,310, filed on Mar. 2, 2016.

(51) Int. Cl. G06F 3/0484; G06F 11/32; G06F 11/34; G06F 11/30

(52) U.S. Cl. CPC G06F 3/04847; G06F 11/3006; G06F 11/328; G06F 11/3495; H04L 67/12

(57) ABSTRACT

A system includes a processor, memory, and an analytics engine configured to receive an analytic program associated with analysis of a machine asset in an IIoT, display a UI to a user, the UI including a first field associated with an input parameter of the analytic program, a second field associated with an output field of the analytic program, and the plurality of data model fields, receiving an input associated with the first field on the UI identifying a selection of a first data model field of the plurality of data model fields, receiving an input associated with the second field on the UI identifying a selection of a second data model field of the plurality of data model fields, executing the analytic program using the first data model field as the input parameter, and storing the output of the analytic program based on the second data model field.

### CLAIM OF PRIORITY

This application claims the benefit of priority to U.S. Provisional Application Ser. No. 62/302,310, filed on Mar. 2, 2016, which is incorporated herein by reference in its entirety.

### TECHNICAL FIELD

This application relates generally to machine analytics. More particularly, this application relates to analytics of fleet assets in an Industrial Internet of Things.

### BACKGROUND

The traditional Internet of Things (loT) involves the connection of various consumer devices, such as coffee pots and alarm clocks, to the Internet to allow for various levels of control and automation of those devices. The Industrial Internet of Things (IIoT), on the other hand, involves connecting industrial assets as opposed to consumer devices. There are technical challenges involved in interconnecting diverse industrial assets, such as wind turbines, jet engines, and locomotives, which simply do not exist in the realm of consumer devices.

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating a system, in accordance with an example embodiment, implementing an IIoT.

FIG. 2 is a block diagram illustrating different edge connectivity options that an IIoT machine provides, in accordance with an example embodiment.

FIG. 3 is a block diagram illustrating an analytics engine, in accordance with an example embodiment, providing an analytic service in the IIoT system.

FIG. 4 illustrates an example GUI provided by the analytics engine.

FIG. 5 illustrates a computer-implemented method, in accordance with an example embodiment, for providing analytic services in the IIoT system.

FIG. 6 is a block diagram illustrating a representative software architecture which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art that embodiments of the disclosed subject matter may be practiced without these specific details. In general, well-known instruction instances, protocols, structures, and techniques have not been shown in detail.

Some of the technical challenges involved in an IIoT include items such as predictive maintenance (e.g., where industrial assets can be serviced prior to problems developing to reduce unplanned downtimes), or commercial planning and use of assets (e.g., how to deploy assets or manage maintenance of assets within the fleet to maximize use or commercial value), or managing purchasing decisions (e.g., when to sunset assets from the fleet or purchase new assets into the fleet). For example, in aviation, fleet managers may wish to analyze daily performance of jet engines. A developer may create an analytical program (“analytic”), such as a shift detection analytic, to detect a shift in engine temperature, inlet engine oil pressure, or outlet engine oil pressure. This analytic may rely on various inputs, such as noise level, various time series sensor data (e.g., engine temperature, inlet engine oil pressure, outlet engine oil pressure), and classification thresholds (e.g., for low, medium, and high classifications).

As asset management and maintenance analytics become more sophisticated, engineers are frequently coming up with different ways of analyzing industrial assets for strategic decision-making. Some fleets of assets, however, may be numerous and cumbersome, hampering conventional methods of analytics development (e.g., custom programming) and deployment. In conventional asset management, it may take months or years to get new analytics developed and scale (e.g., deploy) to the full fleet.

For example, one conventional approach to developing such analytics includes configuring the analytic to connect directly to the data source (e.g., develop the software to read from and write to the time series data source, or the asset data source). However, under this methodology, data connectors need to be developed in the same programming language as the analytic. If the analytic is developed, for example, in a non-general purpose programming language such as R, the level of programming difficulty or programmer experience may be high. Further, in scenarios where the data sources can only be accessed via a proprietary protocol, it may not be possible to develop a data connector between the analytic and the data source. In addition, if a later version of the analytic is written in a different programming language than the previous analytic, a new data connector would also need to be developed, causing further programming burden. Moreover, in a typical diagnostic and monitoring application, there may be many analytics, with each analytic depending on a set of data connectors. In situations where a slight change is required,

In an example embodiment, an analytics engine collects data from an industrial fleet of assets in an IIoT (e.g., 40,000 engines in an airline fleet) that may be used to analyze and address various asset management challenges. The analytics engine monitors asset data, analyzing, for example, how assets are currently behaving versus previous (e.g., expected) behavior, and aggregating asset data across the fleet. The analytics engine provides a cloud-based analytics platform that enables asset managers to develop and deploy custom analytics (e.g., an executable for analyzing some aspect asset performance), scaled out to their fleet of assets, and leveraging the IIoT data in the cloud. The analytics engine enables asset managers to avoid some of the problems with custom software development and deployment, allowing asset managers to integrate and deploy a new analytic with an existing suite of analytics, and on an industrial scale using the cloud-based IIoT.

The analytics engine provides a data framework format used to describe inputs and outputs of analytics deployed through the analytics engine. In an example embodiment, a developer of the analytic provides the analytic (e.g., the executable, or source code configured to evaluate output data from the assets) to the analytics engine. Further, the developer configures an analytic template, in the data framework format, that defines the inputs and outputs of the analytic (e.g., the data types of input fields used by the executable, and the data types of output fields generated by the executable) and provides the analytic template to the analytic engine along with the analytic service.

Using the analytic template, the analytic engine also provides a display interface (e.g., graphical user interface (GUI)) that enables a user (e.g., the developer, or the asset manager) that may be used by the developer to define an analytic I/O mapping. Through the analytic I/O mapping, the user configures a data source for each input field defined in the analytic template, as well as a data target for each output field defined in the analytic template (e.g., where the input data is to come from, and where the output data is to be written). The analytic engine enforces source data selection for each input and output field based on field constraints defined in the analytic template (e.g., only enabling the user to select sources with matching data types). As such, the user selects data sources and targets through the GUI, thereby configuring the analytic I/O mapping for runtime.

At runtime, the analytic engine uses the analytic template and analytic I/O mapping to execute the analytic. In an example embodiment, the analytic engine uses user-supplied data readers and writers to read and write from the user's data sources (e.g., as defined by the analytic L/O mapping). The analytic engine defines a data interface using a “getter/setter” pattern. The analytic engine issues “getter” calls to retrieve the input data and passes that input data to the analytic service. The analytic engine formats the input data based on the analytic template, executes the analytic with the input data, and issues “setter” calls to transfer the output data to the output target (e.g., as defined by the analytic I/O mapping). Such service wrapping enables users to configure and deploy cloud-based analytics across their fleet of assets. Such a loose coupling allows the developer to assemble the application solution by configuration, and without needing to re-code the analytic.

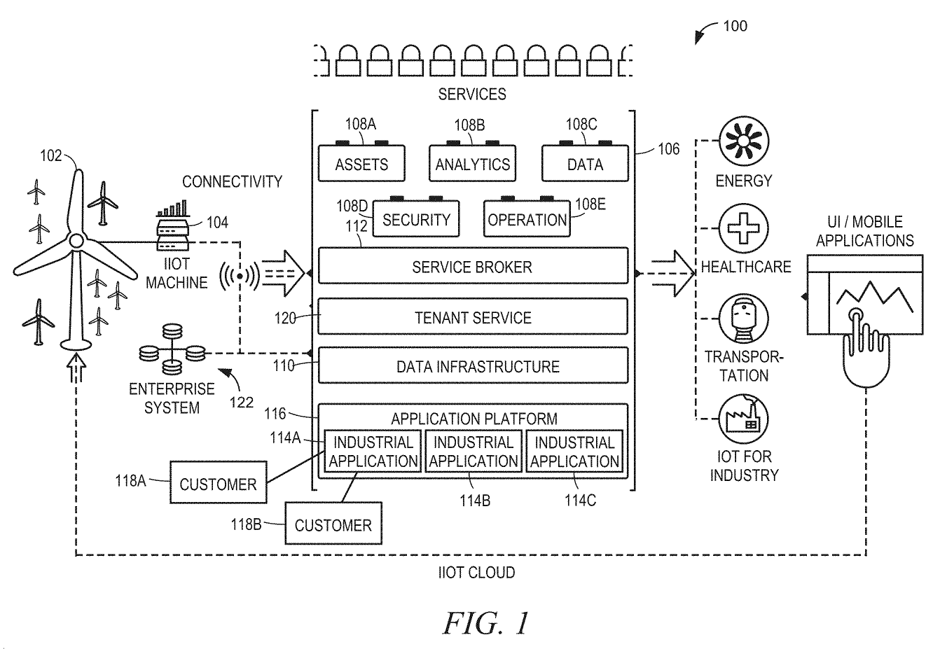

FIG. 1 is a block diagram illustrating a system 100, in accordance with an example embodiment, implementing an IIoT. An industrial asset 102, such as a wind turbine as depicted here, may be directly connected to an IIoT machine 104. The IIoT machine 104 is a software stack that can be embedded into hardware devices such as industrial control systems or network gateways. The software stack may include its own software development kit (SDK). The SDK includes functions that enable developers to leverage the core features described below.

One responsibility of the IIoT machine 104 is to provide secure, bi-directional cloud connectivity to, and management of, industrial assets 102, while also enabling applications (analytical and operational services) at the edge of the IIoT. The latter permits the delivery of near-real-time processing in controlled environments. Thus, the IIoT machine 104 connects to an IIoT cloud 106, which includes various modules, including asset module 108A, analytics module 108B, data module 108C, security module 108D, and operations module 108E, as well as data infrastructure 110. This allows other computing devices, such as client computers, running user interfaces/mobile applications to perform various analyses of either the individual industrial asset 102 or assets of the same type.

The IIoT machine 104 also provides security, authentication, and governance services for endpoint devices. This allows security profiles to be audited and managed centrally across devices, ensuring that assets are connected, controlled, and managed in a safe and secure manner, and that critical data is protected.

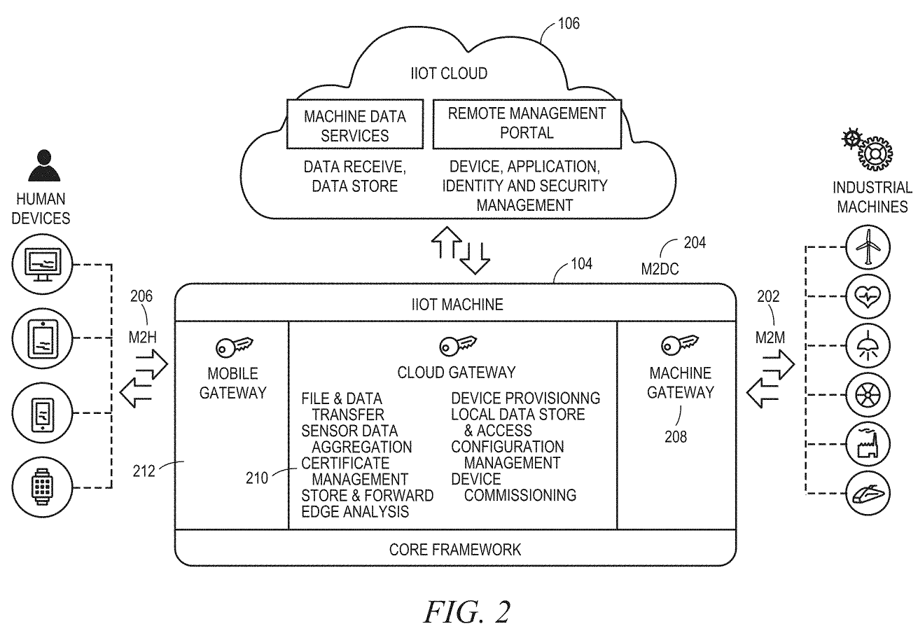

In order to meet requirements for industrial connectivity, the IIoT machine 104 can support gateway solutions that connect multiple edge components via various industry standard protocols. FIG. 2 is a block diagram illustrating different edge connectivity options that an IIoT machine 104 provides, in accordance with an example embodiment. There are generally three types of edge connectivity options that an IIoT machine 104 provides: machine gateway (M2M) 202, cloud gateway (M2DC) 204, and mobile gateway (M2H) 206.

Many assets may already support connectivity through industrial protocols such as Open Platform Communication (OPC)-UA or ModBus. A machine gateway component 208 may provide an extensible plug-in framework that enables connectivity to assets via M2M 202 based on these common industrial protocols.

A cloud gateway component 210 connects an IIoT machine 104 to an IIoT cloud 106 via M2DC 204, and to an enterprise system 122.

A mobile gateway component 212 enables people to bypass the IIoT cloud 106 and establish a direct connection to an asset 102. This may be especially important for maintenance scenarios. When service technicians are deployed to maintain or repair machines, they can connect directly from their machine to understand the asset's operating conditions and perform troubleshooting. In certain industrial environments, where connectivity can be challenging, the ability to bypass the cloud and create this direct connection to the asset may be significant.

As described briefly above, there are a series of core capabilities provided by the IIoT system 100. Industrial scale data, which can be massive and is often generated continuously, cannot always be efficiently transferred to the cloud for processing, unlike data from consumer devices. Edge analytics provide a way to preprocess the data so that only the pertinent information is sent to the cloud. Various core capabilities provided include file and data transfer, store and forward, local data store and access, sensor data aggregation, edge analytics, certificate management, device provisioning, device decommissioning, and configuration management.

As described briefly above, the IIoT machine 104 can be deployed in various different ways. These include on the cloud gateway component 210, on controllers, or on sensor nodes. The gateway acts as a smart conduit between the IIoT cloud 106 and the asset(s) 102. The IIoT machine 104 may be deployed to provide connectivity to asset(s) 102 via a variety of protocols.

The IIoT machine 104 can be deployed directly onto machine controller units. This decouples the machine software from the machine hardware, allowing connectivity, upgradability, cross-compatibility, remote access, and remote control. It also enables industrial and commercial assets that have traditionally operated standalone or in very isolated networks to be connected directly to the IIoT cloud 106 for data collection and live analytics.

The IIoT machine 104 can be deployed on sensor nodes. In this scenario, the intelligence lives in the IIoT cloud 106 and simple, low-cost sensors can be deployed on or near the asset(s) 102. The sensors collect machine and environmental data and then backhaul this data to the IIoT cloud 106 (directly or through an IIoT gateway), where it is stored, analyzed, and visualized.

Customers or other users may create applications to operate in the IIoT cloud 106. While the applications reside in the IIoT cloud 106, they may rely partially on the local IIoT machines 104 to provide the capabilities to gather sensor data, process it locally, and then push it to the IIoT cloud 106.

The IIoT cloud 106 enables the IIoT system 100 by providing a scalable cloud infrastructure that serves as a basis for platform-as-a-service (PaaS), which is what developers use to create Industrial Internet applications for use in the IIoT cloud.

Referring back to FIG. 1, services provided by the IIoT cloud and generally available to applications designed by developers include asset services from asset module 108A, analytics services from analytics module 108B, data services from data module 108C, application security services from security module 108D, and operational services from operations module 108E.

Asset services include services to create, import, and organize asset models and their associated business rules. Data services include services to ingest, clean, merge, and ultimately store data in the appropriate storage technology so that it can be made available to applications in the manner most suitable to their use case.

Analytics services include services to create, catalog, and orchestrate analytics that will serve as the basis for applications to create insights about industrial assets. Application security services include services to meet end-to-end security requirements, including those related to authentication and authorization.

Operational services enable application developers to manage the lifecycle and commercialization of their applications. Operational services may include development operational services, which are services to develop and deploy Industrial Internet applications in the cloud, as well as business operational services, which are services that enable transparency into the usage of Industrial Internet applications so that developers can ensure profitability.

The asset model may be the centerpiece of many, if not all, Industrial Internet applications. While assets are the instantiations of asset types (types of industrial equipment, such as turbines), the asset model is a digital representation of the asset's structure. In an example embodiment, the asset service provides Application Program Interfaces (APIs), such as Representational State Transfer (REST) APIs that enable application developers to create and store asset models that define asset properties, as well as relationships between assets and other modeling elements. Application developers can then leverage the service to store asset-instance data. For example, an application developer can create an asset model that describes the logical component structure of all turbines in a wind farm and then create instances of that model to represent each individual turbine. Developers can also create custom modeling objects to meet their own unique domain needs.

In an example embodiment, the asset module 108A may include an API layer, a query engine, and a graph database. The API layer acts to translate data for storage and query in the graph database. The query engine enables developers to use a standardized language, such as Graph Expression Language (GEL), to retrieve data about any object or property of any object in the asset service data store. The graph database stores the data.

An asset model represents the information that application developers store about assets, how assets are organized, and how they are related. Application developers can use the asset module 108A APIs to define a consistent asset model and a hierarchical structure for the data. Each piece of physical equipment may then be represented by an asset instance. Assets can be organized by classification and by any number of custom modeling objects. For example, an organization can use a location object to store data about where its pumps are manufactured, and then use a manufacturer object to store data about specific pump suppliers. It can also use several classifications of pumps to define pump types, assign multiple attributes, such as Brass or Steel, to each classification, and associate multiple meters, such as Flow or Pressure, to a classification.

Data services from the data module 108C enable Industrial Internet application developers to bring data into the system and make it available for their applications. This data may be ingested via an ingestion pipeline that allows for the data to be cleansed, merged with data from other data sources, and stored in the appropriate type of data store, whether it be a time series data store for sensor data, a Binary Large Object (BLOB) store for medical images, or a relational database management system (RDBMS).

Since many of the assets are industrial in nature, much of the data that will commonly be brought into the IIoT system 100 for analysis is sensor data from industrial assets. In an example embodiment, a time series service may provide a query efficient columnar storage format optimized for time series data. As the continuous stream of information flows from sensors and needs to be analyzed based on the time aspect, the arrival time of each stream can be maintained and indexed in this storage format for faster queries. The time series service also may provide the ability to efficiently ingest massive amounts of data based on extensible data models. The time series service capabilities address operational challenges posed by the volume, velocity, and variety of IIoT data, such as efficient storage of time series data, indexing of data for quick retrieval, high availability, horizontal scalability, and data point precision.

The application security services provided by the security module 108D include user account and authentication (UAA) and access control. The UAA service provides a mechanism for applications to authenticate users by setting up a UAA zone. An application developer can bind the application to the UAA service and then use services such as basic login and logout support for the application, without needing to recode these services for each application. Access control may be provided as a policy-drive authorization service that enables applications to create access restrictions to resources based on a number of criteria.

Thus, a situation arises where application developers wishing to create industrial applications for use in the IIoT may wish to use common services that many such industrial applications may use, such as a log-in page, time series management, data storage, and the like. The way a developer can utilize such services is by instantiating instances of the services and then having their applications consume those instances. Typically, many services may be so instantiated.

Customers 118A-118B may then interact with applications 114A-114C to which they have subscribed. Here, for illustrative purposes, customers 118A and 118B are both tenants of application 114A. A tenant service 120 may be used to manage tenant-related modifications, such as management of templates and creation of tenants.

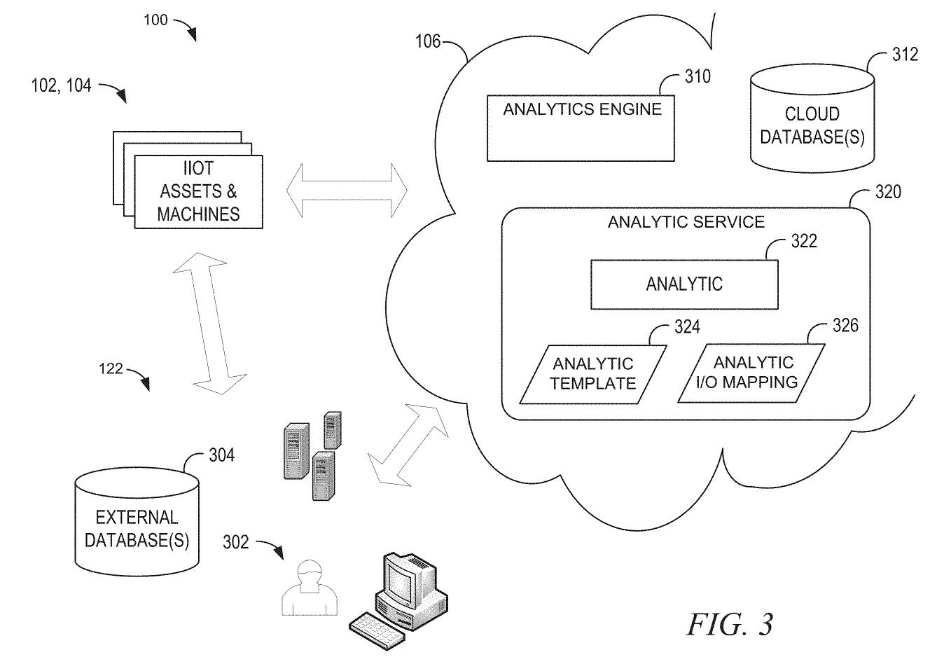

FIG. 3 is a block diagram illustrating an analytics engine 310, in accordance with an example embodiment, providing an analytic service 320 in the IIoT system 100. The analytics engine 310 may be similar to analytics module 108B. A user 302 (e.g., a developer of analytics) develops an analytic (or “analytic program”) 322 configured to analyze aspects of operation of the IIoT assets 102 (e.g., via data collected from associated IIoT machines 104). For example, the analytic 322 may be an executable, or a script, or source code configured to analyze aspects of fleet management, predictive maintenance, commercial planning. In some embodiments, the analytics engine 310 may compile the analytic 322 (e.g., into an executable) prior to use. The analytics engine 310 enables the user 302 to deploy the analytic 322 within a cloud-based analytic service 320 within the IIoT cloud 106.

In one example, the user 302 develops and implements a shift detection analytic 322 to detect a shift in engine temperature, inlet engine oil pressure, and outlet engine oil pressure in a fleet of aviation engines (e.g., as the industrial assets 102 or IIoT machines 104). This shift detector analytic 322 finds abrupt changes in the mean level of a time series set of data such as engine temperature, inlet oil pressure, and outlet oil pressure, thereby identifying potential problems in the operation of the engine.

To prepare the analytic service 320 for operation, the user 302 configures an analytic template 324 for the analytic 322. The analytic template 324 defines the inputs and outputs of the analytic service 320 (e.g., the data structures, data types of input parameters used by the analytic 322, and the data structures, data types of output fields generated by the analytic 322). In the shift detection example, inputs may include noise level, classification thresholds (e.g., for low, medium, high), and one or more sets of input time series data (e.g., engine temperature readings over time, oil pressure readings over time). The outputs may include detected shifts and shift characteristics (e.g., start date, end date, average, and classification).

The analytics engine 310 defines a data framework format used to construct the analytic template 324. The data framework format includes service identification information such as, for example, a service name, a version identifier, and information for accessing a running version of the analytic service 320. Further, the data framework format also includes service input and output data structures for defining inputs and outputs of the analytic 322.

The input and output data structures are hierarchical structures of named fields and sub-fields used to define each input and each output of the analytic 322. Each field is tagged as either an input or an output field. Each field may have multiple values at runtime (e.g., representing an array) such that the number of values may or may not be fixed (e.g., a variable length array, or a fixed length array). Each field may optionally contain sub-fields. Leaf nodes of the hierarchy are fields with no sub-fields. Leaf nodes are characterized as one of a predefined set of atomic datatypes (e.g., integer, long, double, float, Boolean, byte, string, and time series array and/or single-dimension array variants of each of the other data types, plus a general binary blob). Leaf nodes are also characterized as to whether they are mapped to an input value, and as to whether they have a non-null value at runtime. Leaf nodes may also be characterized as having a runtime value that is greater than, or greater than or equal to, less than, or less than or equal to a defined value, or one of an enumerated set of values.

In one example, presume the analytic 322 compares two time series data sets (e.g., aligned with time stamps), counting the number of divergences (e.g., x values different from y values) that exceed a set of thresholds. The thresholds identify the cut-off values for classifying each pair of values from the time series inputs as being in a low, medium, or high divergent relationship. The analytic 322 outputs the number of divergences in each of the high, medium, and low categories. As such, in this example, the analytic 322 expects the input to contain a time series value labelled as ‘X’, and another time series value labelled as ‘Y’. It also accepts a ‘low divergence threshold’ value (e.g., value pairs whose difference is below this threshold are not considered to be divergent), a ‘low-medium divergence threshold’ value, and a ‘medium-high threshold’ value. Value pairs whose difference is between the low and low-medium thresholds are considered to be in low divergence, pairs whose difference is between low-medium and medium-high are considered to be in medium divergence, and pairs whose difference is above the medium-high threshold are considered to be in high divergence. Further, the service outputs three values labelled as ‘high divergence count’, ‘medium divergence count’, and ‘low divergence count’.

In this example, the user 302 may configure the analytic template 324 as such:

```
{Analytic Template:
    {serviceName: Divergence Counter,
    service-Version: 1.0,
    deployedURI: https:/<tenant info>/analytics/outlierIdentifier/1_0
    inputs:[
        {name: X,
        portType: leaf,
        singleInstance: true,
        dataType: FloatTimeseries,
        mustBeMapped: true,
        runtimeValueMustBeNonNull: true
        },
        {name: Y,
        portType: leaf,
        singleInstance: true
        dataType: FloatTimeseries,
        mustBeMapped: true,
        runtimeValueMustBeNonNull: true
        },
        {name: divergence thresholds,
        portType: composite,
        singleInstance: true,
        children: [
              {name: high-med threshold,
              portType: leaf,
              singleInstance: true,
              dataType: Float,
              mustBeMapped: true,
              runtimeValueMustBeNonNull: true,
              greaterThan:0
              },
              {name: med-low threshold,
              portType: leaf,
              singleInstance: true,
              dataType; Float,
              mustBeMapped: true,
              runtimeValueMustBeNonNull: true,
            greaterThan:0
            },
            {name: minimum divergence threshold,
            portType: leaf,
            singleInstance: true,
            dataType: Float,
            mustBeMapped: true,
            runtimeValueMustBeNonNull: true,
            greaterThan:0
            }
          ]
        },
    ],
    outputs:[
        {name: high divergence count,
          portType: leaf,
          singleInstance: true
        },
        {name: medium divergence count,
        portType: leaf,
        singleInstance: true
        },
        {name: low divergence count,
        portType: leaf,
        singleInstance: true
        }
        ]
    }
    }
```

Thus, the user 302 configures the analytic template 324, in the data framework format provided by the analytics engine 310, based on the demands (e.g., the inputs and outputs) of the analytic 322.

In addition to the analytic template 324, the analytic service 320 also includes an analytic I/O mapping 326. For each input and output field defined in the analytic template 324, the analytic service 320 maps data sources (e.g., for inputs) and data targets (e.g., for outputs) that are used during operation (e.g., during execution of the analytic 322, at runtime). The input data sources provide data regarding the IIoT assets 102 (e.g., from the IIoT machines 104). The output data targets are where the output data of the analytic 322 are sent (e.g., written, stored). The data sources and data targets may be cloud databases 312 or external databases 304 (e.g., from the enterprise system 122).

In the shift detection example, data sources may include, for example, constants for noise level or the classification thresholds (e.g., hard-coded configuration values where such constants may be specific to particular assets or types of assets), or time series data sources accessed via a time series data service (e.g., sensor data previously collected from asset sensors at periodic time intervals), or an asset data source (e.g., a model of an asset, its parts, characteristics, and so forth). In industrial monitoring and diagnostics, an asset may be a piece of machinery. In health care, an asset may be a person and/or machinery. In financial services, an asset may be a contract.

Continuing the shift detection example, the airplane engine may be the top-level asset. The model may include sensors for engine temperature, inlet engine oil pressure, and outlet engine oil pressure. The model may also include noise level of the sensors. The model may also include a reference to a time series data source where the time series sensor data is stored for each sensor (“time series tag name”). The model may also include one or more classification thresholds used to indicate thresholds between low, medium, and high. The model may also include the shift detected for each sensor.

The analytic template 324 for the example shift detection analytic 322 may include, for example:

```
{
  “analyticName”: “Multi-parameter Shift Detector”,
  “analyticVersion”: “V1.0”,
  “inputPortDefinitions”: [
  {
    “portName”: “parameterSet”,
    “portType”: “COMPOSITE”,
    “required”: true,
    “variable”: true,
    “childrenPorts”: [
    {
      “portName”: “parameterTable”,
      “portType”: “TIMESERIES_ARRAY”,
      “variable”: true,
      “required”: true,
      “columns”: [
      {
        “portName”: “parameter”,
        “portType”: “FIELD”,
        “variable”: false,
        “dataType”: “DOUBLE_ARRAY”,
        “required”: true
      }
      ]
    },
    {
      “portName”: “constants”,
      “portType”: “COMPOSITE”,
      “variable”: false,
      “childrenPorts”: [
      {
        “portName”: “alpha”,
        “portType”: “FIELD”,
        “variable”: false,
        “dataType”: “DOUBLE”,
        “required”: true
      },
      {
        “portName”: “noise”,
        “portType”: “FIELD”,
        “variable”: false,
        “dataType”: “DOUBLE”,
        “required”: true
      },
      {
        “portName”: “classificationThresholds”,
        “portType”: “COMPOSITE”,
        “variable”: false,
        “required”: true,
        “childrenPorts” : [
        {
          “portName”: “highThreshold”,
          “portType”: “FIELD”,
          “variable”: false,
          “dataType”: “DOUBLE”,
          “required”: true
        },
        {
          “portName”: “medThreshold”,
          “portType”: “FIELD”,
          “variable”: false,
          “dataType”: “DOUBLE”,
          “required”: true
        },
        {
          “portName”: “lowThreshold”,
          “portType”: “FIELD”,
          “variable”: false,
          “dataType”: “DOUBLE”,
          “required”: true
        }
        ]
      }
      ]
    }
    ]
  }
  ],
  “outputPortDetinitions”: [
  {
    “portName”: “shift”,
    “portType”: “COMPOSITE”,
    “variable”: true,
    “childrenPorts” : [
    {“portName” : “startDate”,
    “portType” : “FIELD”,
    “variable” : false,
      “dataType” : “DOUBLE”
    },
      {“portName” : “endDate”,
      “portType” : “FIELD”,
      “variable” : false,
      “dataType” : “DOUBLE”
      },
      {“portName” : “average”,
      “portType” : “FIELD”,
      “variable” : false,
      “dataType” : “DOUBLE”
      },
      {“portName” : “classification”,
      “portType” : “FIELD”,
      “variable” : false,
      “dataType” : “STRING”
      }
    ]
    }
  ]
  }
```

The analytic template 324 is defined according to the given input structure and the time series data type of the input port, and identifies how to format the data for the analytic 322. As such, the analytic template 324 defines an analytic named “Multi-parameter Shift Detector”. This example analytic template 324 defines inputs including a TIMESERIES_ARRAY named “parameterTable”, and several constants including a DOUBLE named “alpha”, a DOUBLE named “noise”, and COMPOSITE of “classificationThresholds” including a “highThreshold”, a “medThreshold”, and a “lowThreshold”. The analytic template 324 also defines outputs including DOUBLEs named “startDate”, “endDate”, “average”, and “classification”.

Input data for the shift detector analytic 322 may come from a secondary source (e.g., a database storing such analytic data), or directly from the assets 102, 104 themselves. Example input data for the shift detector analytic 322 may include, for example:

```
{
  “parameterSet”: [
  {
    “parameterTable”: [
    {
      “time_stamp”: [
      100001,
      100002,
      100003,
      100004,
      100005,
      100006,
      100007,
      100008,
      100009,
      100010,
      100011,
      100012
      ],
      “parameter”: [
      73.1,
      73.5,
      73.4,
      73.3,
      73.6,
      73.7,
      73.9,
      73.2,
      73.1,
      73.4,
      73.5,
      73.9
      ]
    }
    ],
    “constants”: {
    “alpha”: 0.2,
    “noise”: 20.0,
    “classificationThresholds”: {
      “highThreshold”: 100.0,
      “medThreshold”: 80.0,
      “lowThreshold”: 50.0
    }
    }
  },
  {
    “parameterTable”: [
    {
      “time_stamp”: [
      100001,
      100002,
      100003,
      100004,
      100005,
      100006,
      100007,
      100008,
      100009,
      100010,
      100011
      100012
      ],
      “parameter”: [
      10.1,
      10.5,
      10.4,
      10.3,
      10.6,
      10.7,
      10.9,
      10.2,
      10.1,
      10.4,
      10.5,
      10.9
      ]
    },
    {
      “time_stamp”: [
      100001,
      100002,
      100003,
      100004,
      100005,
      100006,
      100007,
      100008,
      100009,
      100010,
      100011,
      100012
      ],
      “parameter”: [
      12.1,
      12.5,
      12.4,
      12.3,
      12.6,
      12.7,
      12.9,
      12.2,
      12.1,
      12.4,
      12.5,
      12.9
      ]
    }
    ],
    “constants”: {
    “alpha”: 0.2,
    “noise”: 5.0,
    “classificationThresholds”: {
      “highThreshold”: 14.0,
      “medThreshold”: 10.0,
      “lowThreshold”: 5.0
      }
    }
    }
  ]
  }
```

The example input data, as prepared for the analytic 322 by the analytic engine 310 using the analytic template 324, includes three time series and associated constants for interpreting each associated time series. The “time_stamp” and “parameter” data represent data values about the asset 102, 104, and the “constants” represent the analytic values provided by the developer for this particular analytic 322, or particular to this particular asset 102, 104.

To make use of the shift detection analytic 322, the developer defines the data sources and targets for the input and output fields of the analytic 322 in the analytic I/O mapping 326. The analytic I/O mapping 326 identifies how to retrieve the data from the time series data source, as well as how to handle the output data (e.g., parsing the data into an output format). The analytic I/O mapping 326 for the example shift detection analytic 322 may include, for example:

```
{
  “analyticName”: “mpsd”,
  “analyticVersion”: “V1.0”,
  “orchestrationStepId”: “find common shifts”,
  “iterations”: [
  {
    “inputMaps”: [
    {
      “valueSourceType”: “DATA_CONNECTOR”,
      “fullyQualifiedPortName”:
      “parameterSet.0.parameterTable.0.parameter”,
      “fieldId”: “bearing_a_temp”,
      “queryCriteria”: {
      “start”: 1455733669601,
      “end”: 1455733669710
      },
      “engUnit”: “Celsius”,
      “required”: true,
      “dataSourceId”: “SystemX Time Series”
    },
    {
      “valueSourceType”: “CONSTANT”,
      “fullyQualifiedPortName”: “parameterSet.0.constants.alpha”,
      “value”: 0.2
    },
    {
      “valueSourceType”: “CONSTANT”,
      “fullyQualifiedPortName”: “parameterSet.0.constants.noise”,
      “value”: 20.0
    },
    {
      “valueSourceType”: “CONSTANT”,
      “fullyQualifiedPortName”:
“parameterSet.0.constants.classificationThresholds.highThreshold”,
      “value”: 100.0
    },
    {
      “valueSourceType”: “CONSTANT”,
      “fullyQualifiedPortName”:
“parameterSet.0.constants.classificationThresholds.medThreshold”,
      “value”: 80.0
    },
    {
      “valueSourceType”: “CONSTANT”,
      “fullyQualifiedPortName”:
“parameterSet.0.constants.classificationThresholds.lowThreshold”,
      “value”: 50.0
    },
    {
      “valueSourceType”: “DATA_CONNECTOR”,
      “fullyQualifiedPortName”: “parameterSet.1.parameterTable.0.
      parameter”,
      “fieldId”: “inlet_oil_pressure”,
      “queryCriteria”: {
      “start”: 1455733669601,
      “end”: 1455733669710
      },
      “engUnit”: “Celsius”,
      “required”: true,
      “dataSourceId”: “SystemX Time Series”
    },
    {
      “valueSourceType”: “DATA_CONNECTOR”,
      “fullyQualifiedPortName”: “parameterSet.1.parameterTable.1.
      parameter”,
      “fieldId”: “outlet_oil_pressure”,
      “queryCriteria”: {
      “start”: 1455733669601,
      “end”: 1455733669710
      },
      “engUnit”: “Celsius”,
      “required”: true,
      “dataSourceId”: “SystemX Time Series”
    },
    {
      “valueSourceType”: “CONSTANT”,
      “fullyQualifiedPortName”: “parameterSet.1.constants.alpha”,
      “value”: 0.2
    },
    {
      “valueSourceType”: “CONSTANT”,
      “fullyQualifiedPortName”: “parameterSet.1constants.noise”,
      “value”: 5.0
    },
    {
      “valueSourceType”: “CONSTANT”,
      “fullyQualifiedPortName”:
“parameterSet.1.constants.classificationThresholds.highThreshold”,
      “value”: 14.0
    },
    {
      “valueSourceType”: “CONSTANT”,
      “fullyQualifiedPortName”:
“parameterSet.1.constants.classificationThresholds.medThreshold”,
      “value”: 10.0
    },
    {
      “valueSourceType”: “CONSTANT”,
      “fullyQualifiedPortName”:
“parameterSet.1.constants.classificationThresholds.lowThreshold”,
      “value”: 5.0
    }
    ],
    “outputMaps”: [
    {
      “fullyQualifiedPortName”: “shift.0.startDate”,
      “fieldId”: “shift_bearing_a_temp_start_date”,
      “engUnit”: “Celsius”,
      “dataSourceId”: “SystemX Time Series”
    },
    {
      “fullyQualifiedPortName”: “shift.0.endDate”,
      “fieldId”: “shift_bearing_a_temp_end_date”,
      “engUnit”: “Celsius”,
      “dataSourceId”: “SystemX Time Series”
    },
    {
      “fullyQualifiedPortName”: “shift.0.average”,
      “fieldId”: “shift_bearing_a_temp_average”,
      “engUnit”: “Celsius”,
      “dataSourceId”: “SystemX Time Series”
    },
    {
      “fullyQualifiedPortName”: “shift.0.classification”,
      “fieldId”: “shift_bearing_a_temp_classification”,
      “engUnit”: “Celsius”,
      “dataSourceId”: “Systemx Time Series”
    },
    {
      “fullyQualifiedPortName”: “shift.1.startDate”,
      “fieldId”: “shift_inlet_oil_pressure_date”,
      “engUnit”: “Celsius”,
      “dataSourceId”: “SystemX Time Series”
    },
    {
      “fullyQualifiedPortName”: “shift.1.endDate”,
      “fieldId”: “shift_inlet_oil_pressure_date”,
      “engUnit”: “Celsius”,
      “dataSourceId”: “SystemX Time Series”
    },
    {
      “fullyQualifiedPortName”: “shift.1.average”,
      “fieldId”: “shift_inlet_oil_pressure_average”,
      “engUnit”: “Celsius”,
      “dataSourceId”: “SystemX Time Series”
    },
    {
      “fullyQualifiedPortName”: “shift.1:classification”,
      “fieldId”: “shift_inlet_oil_pressure_classification”,
      “engUnit”: “Celsius”,
      “dataSourceId”: “SystemX Time Series”
    },
    {
      “fullyQuatifiedPortName”: “shift.2.startDate”,
      “fieldId”: “shift_outlet_oil_pressure_date”,
      “engUnit”: “Celsius”,
      “dataSourceId”: “SystemX Time Series”
    },
    {
      “fullyQualifiedPortName”: “shift.2.endDate”,
      “fieldId”: “shift_outlet_oil_pressure_date”,
      “engUnit”: “Celsius”,
      “dataSourceId”: “SystemX Time Series”
    },
    {
      “fullyQualifiedPortName”: “shift.2.average”,
      “fieldId”: “shift_outlet_oil_pressure_average”,
      “engUnit”: “Celsius”,
      “dataSourceId”: “SystemX Time Series”
    },
    {
      “fullyQualifiedPortName”: “shift.2.classification”,
      “fieldId”: “shift_outlet_oil_pressure_classification”,
      “engUnit”: “Celsius”,
      “dataSourceId”: “SystemX Time Series”
    }
    ]
  }
  ]
}
```

In the above example, the “inputMaps” segment describes the mapping of inputs for the analytic 322 (e.g., where to get the input data), where the “outputMaps” segment describes the mapping of outputs generated by the analytic 322 (e.g., where to put the output data). Under “inputMaps”, a “DATA_CONNECTOR” identifies a source of data for the analytic, along with associated fields for retrieving that data, preparing the data, and so forth. Each “CONSTANT” (e.g., “alpha”, “noise”, the various thresholds) includes a hard-coded constant “value”. Under “outputMaps”, three “shifts” are included, with each having a “startDate”, an “endDate”, an “average”, and a “classification”.

During operation, the analytic 322 may receive the time series sensor data from the time series data source. For example, sensor data may have been collected for an airplane engine during a flight. Once a day, when the plane is on the ground, the sensor data may be transferred from the plane to the time series data source. The analytic 322 may then be ran to analyze the engine, causing the analytic engine 310 to retrieve the time series data from the time series data source, run the analytic, and detect any shifts that may have occurred during the day's operation of the engine.

Example output for the shift detection analytic 322 may be as follows:

```
{
  “shift”: [
  {
    “startDate”: 100001,
    “endDate”: 100012,
    “average”: 62,
    “classification”: “MEDIUM”
  },
  {
    “startDate”: 100001,
    “endDate”: 100012,
    “average”: 33,
    “classification”: “LOW”
  },
  {
    “startDate”: 100001,
    “endDate”: 100012,
    “average”: 6,
    “classification”: “LOW”
  }
  ]
}
```

As such, this example run of the shift detection analytic 322 with the example analytic template 324, analytic I/O map 326, and the above example inputs causes the analytic 322 to identify three shifts: a “MEDIUM” shift with an average of 62, and two “LOW” shifts with averages of 33 and 6. This output data is then mapped based on the “outputMaps” defined in the analytic I/O map 326.

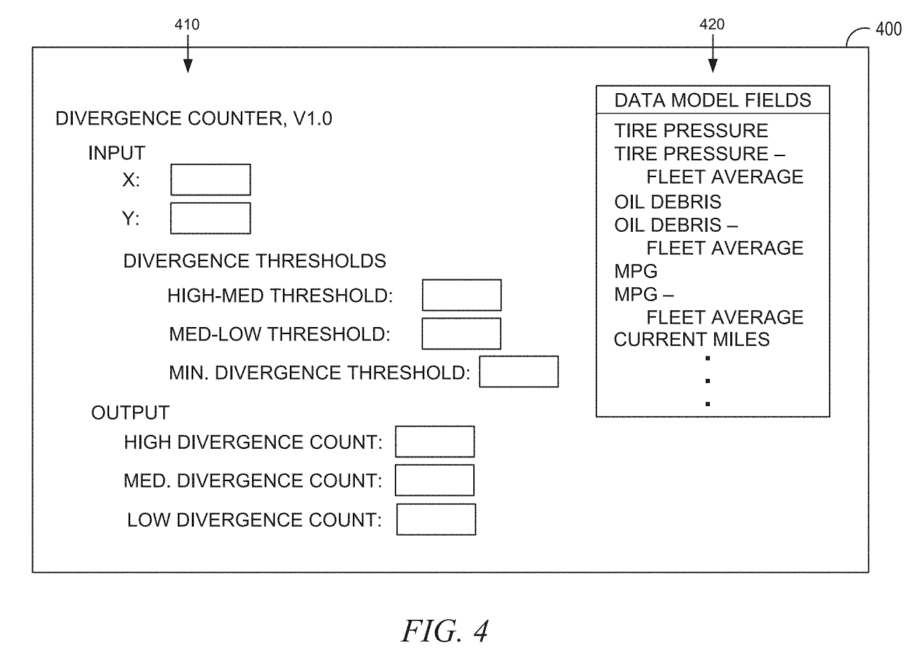

In the example embodiment, the analytics engine 310 provides a graphical user interface (GUI) to the user 302 to define the analytic I/O mapping 326. FIG. 4 illustrates an example GUI 400 provided by the analytics engine 310. The GUI 400 includes a left side 410 associated with the inputs and outputs of the analytic 322, and a right side 420 associated with the data sources and data targets to be used by the analytic service 320 during operation. The user 302 uses the GUI 400 to define the analytic I/O mapping 326, identifying (or “mapping”) which data sources (e.g., database fields) are to be used for each input field, and which data targets are to be used for each output field (e.g., defining a mapping between service input/output fields and data model fields where the data model is defined by the service user).

The analytics engine 310 constructs the left side 410 based on the analytic template 324 defined for the service 320. More specifically, the analytics engine 310 displays mapping fields for each input field and output field in the analytic template 324. The right side 420 is constructed using data model fields (e.g., from the cloud database 312 or the external database 304). The user 302 provides a data model service that exposes the data fields available for use as inputs or to receive the outputs to/from the service 320. During configuration of the analytic I/O mapping 326, the user 302, on the left side 410, identifies data values or sources for each of the inputs, and data targets for each of the outputs. The inputs may be values provided by the user 302 (e.g., a constant value threshold), or the inputs may be data sources selected from the right side 420. For example, the user 302 may select compatible pairs for X and Y from the right side 420, such as “tire pressure” and “tire pressure—fleet average.” Further, the user 302 may input a “min. divergence threshold” of 100 (e.g., degrees Fahrenheit), a “med-low threshold” of 200, and a “med-high threshold” of 400. In other words, values greater than 400 degrees Fahrenheit are high divergence, values between 200 and 400 degrees Fahrenheit are medium divergence, values between 100 and 200 degrees Fahrenheit are low divergence, and values below 100 degrees Fahrenheit are not divergent.

Once the user 302 has completed the GUI, the analytics engine 310 completes configuration of the analytic I/O mapping 326 for the analytic service 320. In another example, the analytic I/O mapping 326 may be:

```
{ Analytic IOMap:
    { serviceName: Divergence Counter,
      serviceVersion: 1.0,
      orchestration: Engine Health,
      orchestration step: divergence computation,
      inputs: {
          { name: X,
            sourceType:fieldMap,
            fieldDef: {
                      datasource: timeseries,
                      fieldId: temperature,
            }
          },
          { name: Y,
            sourceType:fieldMap,
            fieldDef: {
                      datasource: timeseries,
                      fieldId: temperature - fleet average,
            }
          },
          { name: divergence thresholds.high-med threshold,
            sourceType:constant,
            value: 400F
          },
          { name: divergence thresholds.med-low threshold,
            sourceType:constant,
            value: 200F
          },
          { name: divergence thresholds.minimum divergence threshold,
            sourceType:constant,
            value: 100F
          },
      },
      outputs: {
          { name: high divergence count:
            fieldDef: {
                      datasource: timeseries,
                      fieldId: temperature high divergence count,
                }
          },
          { name: med divergence count :
            fieldDef: {
                      datasource: timeseries,
                      fieldId: temperature high divergence count,
                }
            }
      }
    }
}
```

Returning now to FIG. 3, the configuration of the analytic service 320 now includes the analytic template 324, the analytic I/O mapping 326, and the user-provided analytic 322 (e.g., uploaded to the IIoT cloud 106 during the configuration process).

During operation, the analytics engine 310 executes the analytic service 320 using the analytic 322, the analytic template 324, and the analytic I/O mapping 326. The analytics engine 310 also provides runtime tooling that is used during operation (e.g., when the analytic service 320 is invoked). The runtime tooling includes a “service wrapper” for data collection and distribution, and user-supplied data readers and writers that read and write data to/from the data sources and data targets (e.g., in conformance with the data sources and targets provided in the analytic L/O mapping 326). The service wrapper defines a standard interface to the data readers and writers based on a “getter/setter” pattern. The service wrapper reads the analytic I/O mapping 326 configurations, issues getter calls to the supplied data readers, bundles the retrieved data, and passes it to the analytic service 320 in the input formats described by the analytic template 324 and the analytic I/O mapping 326. When the analytic service 320 returns the output values, the tooling uses the data setters to disposition the output from the service 320 as defined by the analytic L/O mapping 326.

The service wrapper behavior is available at three points while executing the service 320. First, the external process that is calling the service 320 may use the service wrapper to collect the data and bundle the data with the call to the service 320 (e.g., the tooling remotely pushing data to the service 320). Second, deploy tooling may add or extend the service entry behavior to collect the data from within the running service (e.g., avoiding passing the data over the communications channel on the service call). Third, collection tooling may expose service field-level getter( ) mechanisms (e.g., from the template 324) to the service 320. For example, the data would not be read from the data sources until it was requested by the service (e.g., service pulling data from the tooling).

In some embodiments, the analytics engine 310 also provides service deploy tooling configured to add runtime features (e.g., as described above) when the service 320 is deployed. The service deploy tooling takes the executable artifacts of the service 320 (e.g., the analytic 322) and extends them with utilities that implement the runtime features as it deploys the service 320 to the target platform.

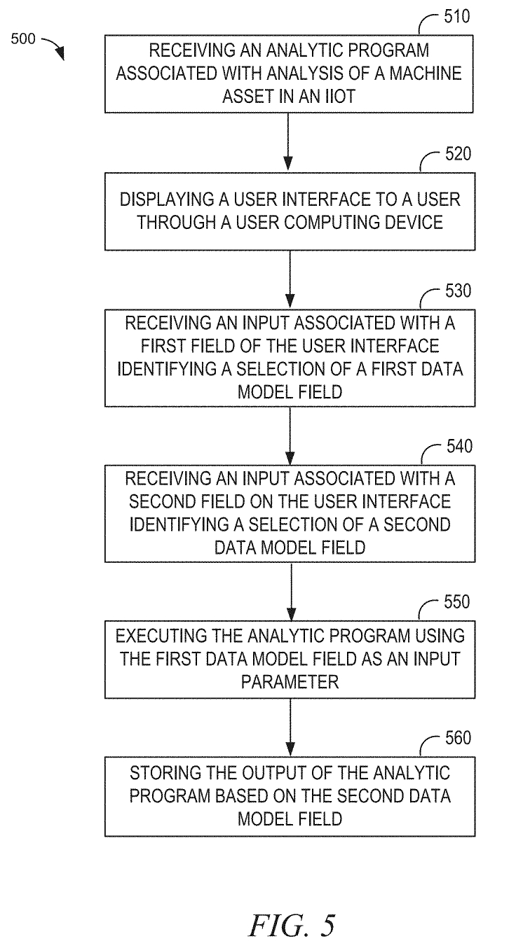

FIG. 5 illustrates a computer-implemented method 500, in accordance with an example embodiment, for providing analytic services in the IIoT system 100. The computer-implemented method 600 is performed by a computing device (e.g., the analytic engine 310) comprising at least one processor and a memory. In the example embodiment, the method 500 receiving an analytic program associated with analysis of a machine asset in an industrial internet of things (operation 510). The method 500 also includes displaying a user interface to a user through a user computing device, the user interface including a first field associated with an input parameter of the analytic program, a second field associated with an output field of the analytic program, and the plurality of data model fields (operation 520). The method 500 further includes receiving an input associated with the first field on the user interface identifying a selection of a first data model field of the plurality of data model fields (operation 530).

The method 500 also includes receiving an input associated with the second field on the user interface identifying a selection of a second data model field of the plurality of data model fields (operation 540). The method 500 further includes executing the analytic program using the first data model field as the input parameter (operation 550). The method 500 also includes storing the output of the analytic program based on the second data model field (operation 560).

In some embodiments, the method 500 also includes, based on said receiving an input associated with the first field, automatically creating an input/output (I/O) map associated with the analytic program, the I/O map identifies an association between the first data model field and the input parameter of the analytic program. In some embodiments, the method 500 also includes, based on said receiving an input associated with the second field, automatically creating an input/output (I/O) map associated with the analytic program, the I/O map identifies an association between the second data model field and the output of the analytic program. In some embodiments, the I/O map describes an output structure associated with one or more output fields of the analytic program, each output filed of the one or more output fields includes a segment identifying a destination for that output field. In some embodiments, the I/O map describes an input structure associated with one or more input fields of the analytic program including a first input field, the input structure for the first input field includes a segment identifying a source for data associated with that first input field.

In some embodiments, the method 500 also includes receiving an analytic template associated with the analytic program, wherein the analytic template identifies (1) a first input data structure defining the input parameter of the analytic program and (2) a first output data structure defining the output field of the analytic program. In some embodiments, the analytic template describes an input structure associated with one or more inputs fields of the analytic program, each input field of the one or more inputs includes a segment identifying a data type of the input field.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-4 are implemented, in some embodiments, in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “Internet of Things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

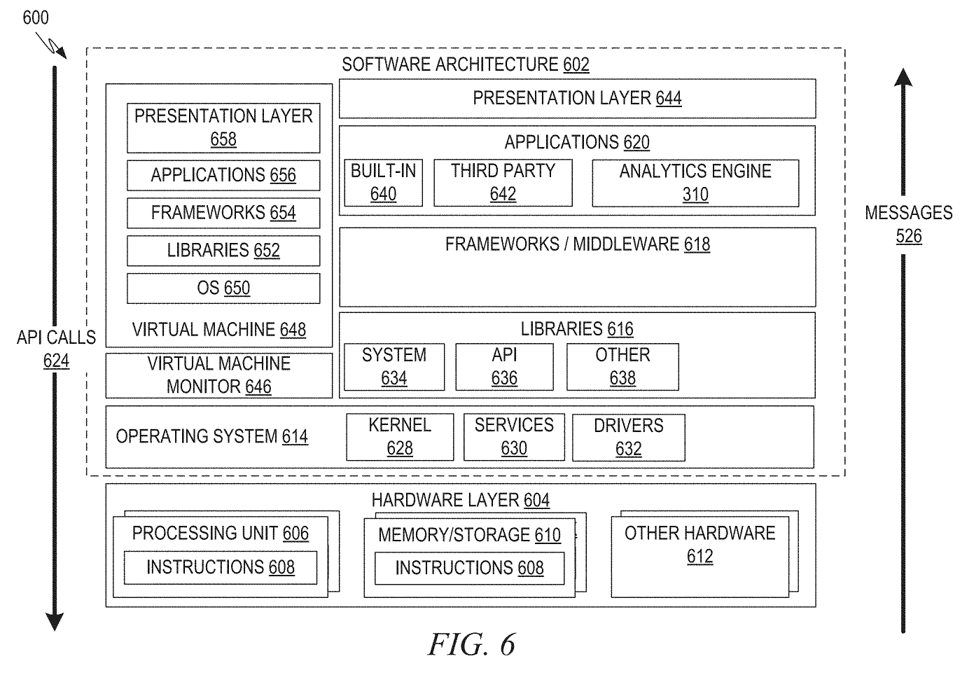

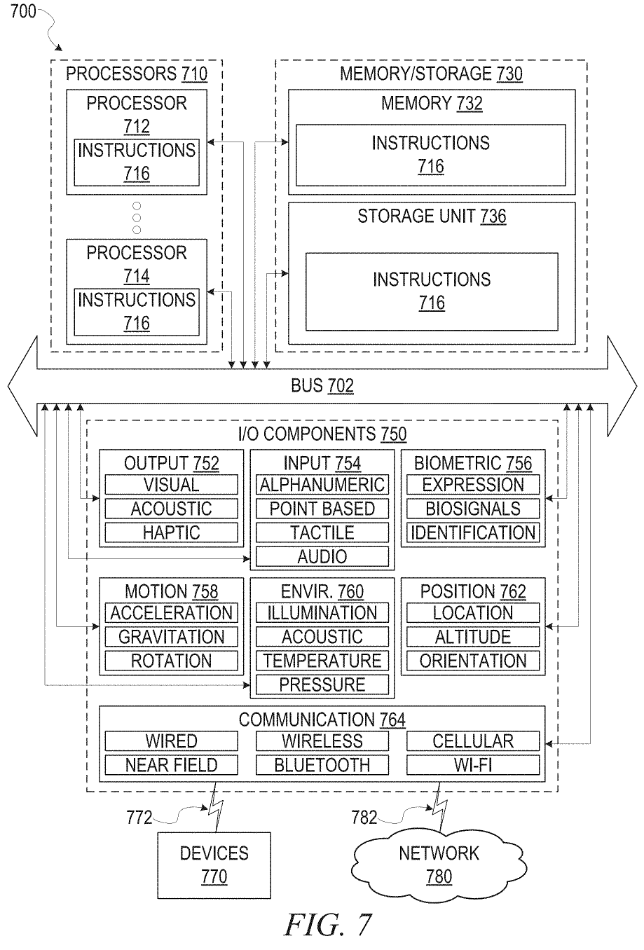

FIG. 6 is a block diagram 600 illustrating a representative software architecture 602, which may be used in conjunction with various hardware architectures herein described. FIG. 6 is merely a non-limiting example of a software architecture 602, and it will be appreciated that many other architectures may be implemented to facilitate the functionality described herein. The software architecture 602 may be executing on hardware such as a machine 700 of FIG. 7 that includes, among other things, processors 710, memory/storage 730, and I/O components 750. A representative hardware layer 604 is illustrated and can represent, for example, the machine 700 of FIG. 7. The representative hardware layer 604 comprises one or more processing units 606 having associated executable instructions 608. The executable instructions 608 represent the executable instructions of the software architecture 602, including implementation of the methods, modules, and so forth of FIGS. 1-4. The hardware layer 604 also includes memory and/or storage modules 610, which also have the executable instructions 608. The hardware layer 604 may also comprise other hardware 612, which represents any other hardware of the hardware layer 604, such as the other hardware illustrated as part of the machine 700.

In the example architecture of FIG. 6, the software architecture 602 may be conceptualized as a stack of layers where each layer provides particular functionality. For example, the software architecture 602 may include layers such as an operating system 614, libraries 616, frameworks/middleware 618, applications 620, and a presentation layer 644. Operationally, the applications 620 and/or other components within the layers may invoke API calls 624 through the software stack and receive a response, returned values, and so forth illustrated as messages 626 in response to the API calls 624. The layers illustrated are representative in nature, and not all software architectures have all layers. For example, some mobile or special purpose operating systems may not provide a frameworks/middleware 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers). Wi-Fi® drivers, audio drivers, power management drivers, and so forth, depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630, and/or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media formats such as MPEG4, H.264. MP3, AAC, AMR, JPG, PNG), graphics libraries (e.g., an OpenGL framework that may be used to render 2D and 3D in a graphic context on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks/middleware 618 may provide a higher-level common infrastructure that may be utilized by the applications 620 and/or other software components/modules. For example, the frameworks/middleware 618 may provide various graphic user interface (GUI) functions, high-level resource management, high-level location services, and so forth. The frameworks/middleware 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows®) Phone, or other mobile operating systems. In this example, the third-party application 642 may invoke the API calls 624 provided by the mobile operating system such as the operating system 614 to facilitate functionality described herein.

The applications 620 may utilize built-in operating system functions (e.g., kemel 628, services 630, and/or drivers 632), libraries (e.g., system libraries 634, API libraries 636, and other libraries 638), and frameworks/middleware 618 to create user interfaces to interact with users of the system 100. Alternatively, or additionally, in some systems, interactions with a user may occur through a presentation layer, such as the presentation layer 644. In these systems, the application/module “logic” can be separated from the aspects of the application/module that interact with a user.

Some software architectures utilize virtual machines. In the example of FIG. 6, this is illustrated by a virtual machine 648. A virtual machine creates a software environment where applications/modules can execute as if they were executing on a hardware machine (such as the machine 700 of FIG. 7, for example). The virtual machine 648 is hosted by a host operating system (operating system 614 in FIG. 6) and typically, although not always, has a virtual machine monitor 646, which manages the operation of the virtual machine 648 as well as the interface with the host operating system (i.e., operating system 614). A software architecture executes within the virtual machine 648, such as an operating system 650, libraries 652, frameworks/middleware 654, applications 656, and/or a presentation layer 658. These layers of software architecture executing within the virtual machine 648 can be the same as corresponding layers previously described or may be different.

### Example Machine Architecture and Machine-Readable Medium

FIG. 7 is a block diagram illustrating components of a machine 700, according to some example embodiments, able to read instructions 716 from a machine-readable medium (e.g., a machine-readable storage medium) and perform any one or more of the methodologies discussed herein. Specifically, FIG. 7 shows a diagrammatic representation of the machine 700 in the example form of a computer system, within which the instructions 716 (e.g., software, a program, an application, an applet, an app, or other executable code) for causing the machine 700 to perform any one or more of the methodologies discussed herein may be executed. For example, the instructions 716 may cause the machine 700 to execute any of the methods described herein. Additionally, or alternatively, the instructions 716 may implement modules of FIG. 1, and so forth. The instructions 716 transform the general, non-programmed machine 700 into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), another processor, or any suitable combination thereof) may include, for example, a processor 712 and a processor 714 that may execute the instructions 716. The term “processor” is intended to include a multi-core processor 712, 714 that may comprise two or more independent processors 712, 714 (sometimes referred to as “cores”) that may execute the instructions 716 contemporaneously. Although FIG. 7 shows multiple processors 710, the machine 700 may include a single processor 712, 714 with a single core, a single processor 712, 714 with multiple cores (e.g., a multi-core processor 712, 714), multiple processors 712, 714 with a single core, multiple processors 712, 714 with multiples cores, or any combination thereof.

The memory/storage 730 may include a memory 732, such as a main memory, or other memory storage, and a storage unit 636, both accessible to the processors 710 such as via the bus 702. The storage unit 636 and memory 732 store the instructions 716 embodying any one or more of the methodologies or functions described herein. The instructions 716 may also reside, completely or partially, within the memory 732, within the storage unit 636, within at least one of the processors 710 (e.g., within the cache memory of processor 712, 714), or any suitable combination thereof, during execution thereof by the machine 700. Accordingly, the memory 732, the storage unit 636, and the memory of the processors 710 are examples of machine-readable media.

As used herein, “machine-readable medium” means a device able to store the instructions 716 and data temporarily or permanently and may include, but not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772 respectively. For example, the communication components 764 may include a network interface component or other suitable device to interface with the network 780. In further examples, the communication components 764 may include wired communication components, wireless communication components, cellular communication components, near field communication (NFC) components, Bluetootht components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code. UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
at least one hardware processor;
a memory storing a plurality of data model fields; and
an analytics engine, executed by the at least one hardware processor, configured to perform operations comprising:
receiving an analytic program associated with analysis of a machine asset in an industrial internet of things;
displaying a user interface to a user through a user computing device, the user interface including a first field associated with an input parameter of the analytic program, a second field associated with an output field of the analytic program, and the plurality of data model fields;
receiving an input associated with the first field on the user interface identifying a selection of a first data model field of the plurality of data model fields;
receiving an input associated with the second field on the user interface identifying a selection of a second data model field of the plurality of data model fields;
executing the analytic program using the first data model field as the input parameter; and
storing the output of the analytic program based on the second data model field.

2. The system of claim 1, the operations further comprising:
based on said receiving an input associated with the first field, automatically creating an input/output (I/O) map associated with the analytic program, the I/O map identifies an association between the first data model field and the input parameter of the analytic program.

3. The system of claim 1, the operations further comprising:
based on said receiving an input associated with the second field, automatically creating an input/output (I/O) map associated with the analytic program, the I/O map identifies an association between the second data model field and the output of the analytic program.

4. The system of claim 3, wherein the I/O map describes an output structure associated with one or more output fields of the analytic program, each output filed of the one or more output fields includes a segment identifying a destination for that output field.

5. The system of claim 3, wherein the I/O map describes an input structure associated with one or more input fields of the analytic program including a first input field, the input structure for the first input field includes a segment identifying a source for data associated with that first input field.

6. The system of claim 1, the operations further comprising:
receiving an analytic template associated with the analytic program, wherein the analytic template identifies (1) a first input data structure defining the input parameter of the analytic program and (2) a first output data structure defining the output field of the analytic program.

7. The system of claim 6, wherein the analytic template describes an input structure associated with one or more inputs fields of the analytic program, each input field of the one or more inputs includes a segment identifying a data type of the input field.

8. A method comprising:
receiving an analytic program associated with analysis of a machine asset in an industrial internet of things;
displaying a user interface to a user through a user computing device, the user interface including a first field associated with an input parameter of the analytic program, a second field associated with an output field of the analytic program, and the plurality of data model fields;
receiving an input associated with the first field on the user interface identifying a selection of a first data model field of the plurality of data model fields;
receiving an input associated with the second field on the user interface identifying a selection of a second data model field of the plurality of data model fields;
executing the analytic program using the first data model field as the input parameter; and
storing the output of the analytic program based on the second data model field.

9. The method of claim 8, further comprising:
based on said receiving an input associated with the first field, automatically creating an input/output (I/O) map associated with the analytic program, the I/O map identifies an association between the first data model field and the input parameter of the analytic program.

10. The method of claim 8, further comprising:
based on said receiving an input associated with the second field, automatically creating an input/output (I/O) map associated with the analytic program, the I/O map identifies an association between the second data model field and the output of the analytic program.

11. The method of claim 10, wherein the I/O map describes an output structure associated with one or more output fields of the analytic program, each output filed of the one or more output fields includes a segment identifying a destination for that output field.

12. The method of claim 10, wherein the I/O map describes an input structure associated with one or more input fields of the analytic program including a first input field, the input structure for the first input field includes a segment identifying a source for data associated with that first input field.

13. The method of claim 8, further comprising:
receiving an analytic template associated with the analytic program, wherein the analytic template identifies (1) a first input data structure defining the input parameter of the analytic program and (2) a first output data structure defining the output field of the analytic program.

14. The method of claim 13, wherein the analytic template describes an input structure associated with one or more inputs fields of the analytic program, each input field of the one or more inputs includes a segment identifying a data type of the input field.

15. A non-transitory machine-readable medium storing processor-executable instructions which, when executed by a processor, cause the processor to perform operations comprising:
receiving an analytic program associated with analysis of a machine asset in an industrial internet of things;
displaying a user interface to a user through a user computing device, the user interface including a first field associated with an input parameter of the analytic program, a second field associated with an output field of the analytic program, and the plurality of data model fields;
receiving an input associated with the first field on the user interface identifying a selection of a first data model field of the plurality of data model fields;
receiving an input associated with the second field on the user interface identifying a selection of a second data model field of the plurality of data model fields;
executing the analytic program using the first data model field as the input parameter; and
storing the output of the analytic program based on the second data model field.

16. The non-transitory machine-readable medium of claim 15, the operations further comprising:
based on said receiving an input associated with the first field, automatically creating an input/output (I/O) map associated with the analytic program, the I/O map identifies an association between the first data model field and the input parameter of the analytic program.

17. The non-transitory machine-readable medium of claim 15, the operations further comprising:
based on said receiving an input associated with the second field, automatically creating an input/output (I/O) map associated with the analytic program, the I/O map identifies an association between the second data model field and the output of the analytic program.

18. The non-transitory machine-readable medium of claim 17, wherein the I/O map describes an output structure associated with one or more output fields of the analytic program, each output filed of the one or more output fields includes a segment identifying a destination for that output field.

19. The method of claim 17, wherein the I/O map describes an input structure associated with one or more input fields of the analytic program including a first input field, the input structure for the first input field includes a segment identifying a source for data associated with that first input field.

20. The method of claim 15, further comprising:
receiving an analytic template associated with the analytic program, wherein the analytic template identifies (1) a first input data structure defining the input parameter of the analytic program and (2) a first output data structure defining the output field of the analytic program.
